(19) United States
(12) Patent Application Publication
(10) Pub. No.: US 2025/0233878 A1
(43) Pub. Date: Jul. 17, 2025

(54) MONITORING DEVICE, MONITORING SYSTEM, AND MONITORING METHOD

(71) Applicant: Panasonic Automotive Systems Co., Ltd., Kanagawa (JP)

(72) Inventors: Ryo HIRANO, Kanagawa (JP); Yoshiharu IMAMOTO, Kanagawa (JP); Seiji SAKAKI, Kanagawa (JP)

(73) Assignee: Panasonic Automotive Systems Co., Ltd., Kanagawa (JP)

(21) Appl. No.: 19/000,148

(22) Filed: Dec. 23, 2024

(30) Foreign Application Priority Data
Jan. 17, 2024 (JP) 2024-005691
Apr. 25, 2024 (JP) 2024-071665

(51) Int. Cl. H04L 9/40

(52) U.S. Cl. CPC H04L 63/1425; H04L 63/101; H04L 63/1441

(57) ABSTRACT

Integrated ECU includes three or more software areas separated by one or more virtual machines or one or more containers. The three or more software areas include first area, second area, and third area. First area has a lower reliability than reliabilities of second area and third area. The reliability indicates invulnerability to falsification by an attacker. Integrated ECU includes communication monitor that belongs to second area and monitors a communication between first area and third area.

### CROSS REFERENCE TO RELATED APPLICATIONS

The present application is based on and claims priority of Japanese Patent Application No. 2024-005691 filed on Jan. 17, 2024, and Japanese Patent Application No. 2024-071665 filed on Apr. 25, 2024.

### FIELD

The present disclosure relates to a monitoring device, a monitoring system, and a monitoring method.

### BACKGROUND

In recent years, on-vehicle systems mounted on vehicles have become more complex in order to provide users with advanced vehicle functions, such as autonomous driving. In order to solve the problem of development time and development costs increasing with increasing complexity of the on-vehicle systems, there is a movement to integrate a plurality of functions into one ECU, which have been mounted separately in a plurality of electronic control units (ECUs). In an integrated ECU, it is conceivable to separate a software area by implementing an external connection function and a vehicle control function mounted on a vehicle as a virtual machine or container using a virtualization technique or a container technique for separating a software area. There is however often a need for vehicle functions to collaborate across virtual machines or containers, which requires communications between the virtual machines or the containers. It is thus impossible to separate the software area completely.

Assume that there is a configuration that enables communications between virtual machines or containers. In this case, unless being managed properly, the communications between the virtual machines or containers may be misused when one of the virtual machines or the containers with the external connection function is falsified. This may damage the virtual machine or the container with the vehicle control function.

Specifically, for example, assume that among on-vehicle systems, an in-vehicle infotainment (IVI) system allowing free install of third-party applications and an advanced driver assistance system (ADAS) for supporting autonomous driving by instructing the vehicle to travel, stop, turn, or other motions are integrated into one ECU. In this case, if a memory area related to the ADAS system is falsified with by a third party's malicious application installed by the IVI system, there arises a serious issue threatening the safety of a vehicle occupant.

With respect to the security technique, there is a known monitoring technique for communications between applications within a host (see e.g., Patent Literature (PTL) 1).

### CITATION LIST

### Patent Literature

PTL 1: Japanese Patent No. 5864039

### SUMMARY

The technique disclosed in PTL 1 however can be improved upon.

To address the problem, the present disclosure provides a monitoring device, a monitoring system, and a monitoring method capable of improving upon the above related art.

A monitoring device according to an aspect of the present disclosure is mounted on a mobility unit. The monitoring device includes: three or more software areas separated by one or more virtual machines or one or more containers. The three or more software areas include a first area, a second area, and a third area. The first area has a lower reliability than reliabilities of the second area and the third area, the reliability indicating invulnerability to falsification by an attacker. The monitoring device further includes a communication monitor that belongs to the second area and monitors a communication between the first area and the third area.

The monitoring device, and so on, according to the present disclosure can improve upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 shows an outline of a monitoring system according to an embodiment.

FIG. 2 is a block diagram showing a configuration of a vehicle system according to the embodiment.

FIG. 3 is a block diagram showing an example configuration of an integrated ECU according to the embodiment.

FIG. 4 shows an example software area according to the embodiment.

FIG. 5 shows an example communication of the integrated ECU according to the embodiment.

FIG. 6 shows an example communication monitoring method by a communication monitor according to the embodiment.

FIG. 7 shows an example system monitoring method by the system monitor according to the embodiment.

FIG. 8 shows an example anomaly coping method by an anomaly handler according to the embodiment.

FIG. 9 is a sequence diagram showing an example sequence of communication monitoring processing by a communication monitor according to the embodiment.

FIG. 10 is a sequence diagram showing an example sequence of system monitoring processing by the system monitor according to the embodiment.

FIG. 11 is a flowchart showing an example flow of communication monitoring processing by the communication monitor according to the embodiment.

FIG. 12 is a flowchart showing an example flow of system monitoring processing by the system monitor according to the embodiment.

FIG. 13 is a flowchart showing an example flow of anomaly coping processing by the anomaly handler according to the embodiment.

FIG. 14 shows an example anomaly display function of the monitoring server according to the embodiment.

### DESCRIPTION OF EMBODIMENT

### Underlying Knowledge Forming Basis of the Present Disclosure

The inventors of the present disclosure found that the technique described in “Background” section has problems as described below.

The technique disclosed in PTL 1 fails to assume the separation of the software area and thus has difficulty in solving the problem described above of misuse of communications between the virtual machines or the containers.

In order to solve such a problem, the inventors of the present disclosure devised the monitoring device, and so on, indicated below.

### [Technique 1]

A monitoring device is mounted on a mobility unit. The monitoring device includes: three or more software areas separated by one or more virtual machines or one or more containers. The three or more software areas include a first area, a second area, and a third area. The first area has a lower reliability than reliabilities of the second area and the third area, the reliability indicating invulnerability to falsification by an attacker. The monitoring device further includes a communication monitor that belongs to the second area and monitors a communication between the first area and the third area.

This configuration can separate three or more software areas using a virtualization technique or a container technique and then monitor inter-area communications. As a result, even if the first area with a relatively low reliability is falsified by an attacker, communication monitoring by the communication monitor cannot be bypassed unless the second area with a relatively high reliability is falsified, which can enhance the security.

### [Technique 2]

This technique is an embodiment of the monitoring device according to Technique 1. The first area includes an external connection function to be communicably connected to an outside of the mobility unit via an external network. The third area includes a safety function that is at least one of: (i) an internal connection function to be communicably connected to an internal network constructed inside the mobility unit; (ii) a mobility unit control function to control the mobility unit; (iii) a mobility unit information notification function to notify of mobility unit information on the mobility unit; (iv) a software update function; or (v) a security function. The second area includes none of the external connection function and the safety function.

Accordingly, the first area is connected to the external network and thus has a relatively low reliability, while the second area and third area are not connected to an external network and thus have relatively high reliabilities. Unless the second area is falsified, no attacker can enter the third area from the first area and abuse the safety function of the third area, which can enhance the security.

### [Technique 3]

This technique is an embodiment of the monitoring device according to Technique 1 or 2. The monitoring device includes four or more software areas separated by the one or more virtual machines or the one or more containers. The four or more software areas include one or more first areas, each being the first area, one or more second areas, each being the second area, and one or more third areas, each being the third area.

This fine separation of the software area enables efficient software development. In addition, a plurality of functions with different levels of risk can be separated into a plurality of areas, which can further enhance the security.

### [Technique 4]

This technique is an embodiment of the monitoring device according to any one of Techniques 1 to 3. Each of the one or more containers is one or more processes or a process group separated by at least one of namespace separation, system call limitation, calculation resource consumption limitation, or forced access control.

This enables the separation of the software area with the least privilege per process unit, which can further enhance the security.

### [Technique 5]

This technique is an embodiment of the monitoring device according to Technique 4. The namespace separation is a separation of at least one of a PID namespace, a network namespace, a mount namespace, an UTS namespace, an UID/GID namespace, or an IPC namespace. The one or more containers limit file access under forced access control or optional access control when not separating the mount namespace.

This enables the separation of proper namespaces and the separation of the software area with the least privilege per process unit, which can further enhance the security.

### [Technique 6]

This technique is an embodiment of the monitoring device according to any one of Techniques 1 to 5. The communication monitor (i) does not monitor a communication within a same area of the first area, the second area, and the third area, (ii) monitors a communication from the first area to the third area, and (iii) does not monitor a communication from the third area to the first area.

This configuration monitors only communications from the first area with a relatively high risk to the third area, and reduces the load of the communication monitoring processing by the communication monitor as compared to the case of monitoring all the communications.

### [Technique 7]

This technique is an embodiment of the monitoring device according to any one of Techniques 1 to 6. Referring to a allow list indicating whether to allow a communication for each source area or each destination area, the communication monitor denies a virtual network communication or a socket communication not allowed on the allow list.

This configuration determines whether to allow a communication for each source area or each destination area, and reduces the load of the communication monitoring processing by the communication monitor as compared to the case of monitoring every single communication.

### [Technique 8]

This technique is an embodiment of the monitoring device according to any one of Techniques 1 to 7. The communication monitor monitors: (i) traffic, a total number of communications, or a total number of interrupts of virtual network communications in a predetermined time period or in a predetermined mobility unit status, or (ii) traffic or a total number of communications of socket communications in the predetermined time period for each source or each source area, and detects an anomaly in the communication between the first area and the third area when a value of a monitoring target exceeds a predetermined threshold.

This configuration can detect an anomaly in the communication, for example, when a huge amount of data is transmitted in an unauthorized manner or when data unsuitable for the vehicle status is transmitted in an unauthorized manner.

### [Technique 9]

This technique is an embodiment of the monitoring device according to any one of Techniques 1 to 8. The communication monitor stores a count value of communications in a memory, the count value being obtained by counting a total number of communications for each source or a total number of communications for each source area, compares the count value of the total number of communications included in a communication between the first area and the third area and a value obtained by adding a predetermined value to the count value of communications stored in the memory, and detects an anomaly in the communication between the first area and the third area when the count value and the value do not match.

This configuration monitors the count value of communications to detect in an unauthorized manner copied communications, spoofed communications, or other improper communications.

### [Technique 10]

This technique is an embodiment of the monitoring device according to any one of Techniques 1 to 9. When allowing a communication between the first area and the third area as a result of executing communication monitoring processing on the communication, the communication monitor assigns, to the communication, an identifier or a signature indicating that the communication monitoring processing has been executed.

This configuration can easily check whether communication monitoring processing by the communication monitor is bypassed based on the presence or absence of the identifier or the signature.

### [Technique 11]

This technique is an embodiment of the monitoring device according to any one of Techniques 1 to 10. The monitoring device further includes: a system monitor that monitors an operating status or a setting of the separation function or a denial event by the separation function at a runtime, the separation function providing the one or more virtual machines or the one or more containers.

When the separation function is disabled, the vehicle control function may be abused for a means other than regular communications. By monitoring the operating status or the settings of the separation function, it can be easily confirmed that the separation function is not disabled.

### [Technique 12]

This technique is an embodiment of the monitoring device according to any one of Techniques 1 to 10. The monitoring device further includes: a system monitor that monitors, at a runtime, at least one of: (i) integrity, a setting, or a calculation resource consumption of a software of a separation function providing the one or more virtual machines or the one or more containers; or (ii) integrity, a setting, or a calculation resource consumption of a software included in the one or more virtual machines or the one or more containers.

This configuration can easily monitor falsification of a software with a separation function that provides a virtual machine or a container or a software included in a virtual machine or a container or an unauthorized operation.

### [Technique 13]

This technique is an embodiment of the monitoring device according to any one of Techniques 1 to 10. The monitoring device further includes: an anomaly handler that copes with an anomaly detected by the communication monitor. The anomaly handler selects a coping means based on at least one of a number of the area in which an anomaly has been detected, an order of anomalies, or a total number of the anomalies. The coping means includes at least one of restart of a system, restart or stop of the one or more virtual machines, restart or stop of the one or more containers, partial denial of a communication, partial stop of a function, log recording, a notification to an external server, or a notification to an occupant of the mobility unit.

This allows recording of a detected anomaly as a log, for example, or can cause the external server or the occupant of the mobility unit that has received the notification to recognize the attack.

### [Technique 14]

This technique is an embodiment of the monitoring device according to Technique 11 or 12. The monitoring device further includes: an anomaly handler that copes with an anomaly detected by the communication monitor. The anomaly handler selects a coping means based on at least one of a number of the area in which an anomaly has been detected, an order of anomalies, or a total number of the anomalies. The coping means includes one of restart of a system, restart or stop of the one or more virtual machines, restart or stop of the one or more containers, partial denial of a communication, partial stop of a function, log recording, a notification to an external server, or a notification to an occupant of the mobility unit.

This allows recording of a detected anomaly as a log, for example, or can cause the external server or the occupant of the mobility unit that has received the notification to recognize the attack.

### [Technique 15]

A monitoring system includes: a monitoring server; and a monitoring device mounted on a mobility unit and communicably connected to the monitoring server via an external network. The monitoring device includes three or more software areas separated by one or more virtual machines or one or more containers. The three or more software areas include a first area, a second area, and a third area. The first area has a lower reliability than reliabilities of the second area and the third area, the reliability indicating invulnerability to falsification by an attacker. The monitoring device further includes: a communication monitor that belongs to the second area and monitors a communication between the first area and the third area; and an external connection function to notify the monitoring server of an anomaly in the communication, when the communication monitor detects the anomaly. The monitoring server has an anomaly display function to display details of the anomaly notified of by the monitoring device and an area in which the anomaly has occurred in association with each other.

This configuration can separate three or more software areas using a virtualization technique or a container technique and then monitor inter-area communications. As a result, even if the first area with a relatively low reliability is falsified by an attacker, communication monitoring by the communication monitor cannot be bypassed unless the second area with a relatively high reliability is falsified, which can enhance the security.

### [Technique 16]

A monitoring method uses a monitoring device mounted on a mobility unit. The monitoring device includes three or more software areas separated by one or more virtual machines or one or more containers. The three or more software areas include a first area, a second area, and a third area. The first area has a lower reliability than reliabilities of the second area and the third area, the reliability indicating invulnerability to falsification by an attacker. The monitoring device further includes a communication monitor that belongs to the second area. The monitoring method includes: monitoring a communication between the first area and the third area, using the communication monitor.

This method can separate three or more software areas using a virtualization technique or a container technique and then monitor inter-area communications. As a result, even if the first area with a relatively low reliability is falsified by an attacker, communication monitoring by the communication monitor cannot be bypassed unless the second area with a relatively high reliability is falsified, which can enhance the security.

Note that these general and specific aspects of the present disclosure may be implemented using a system, a method, an integrated circuit, a computer program, or a computer-readable recording medium, such as a CD-ROM, or any combination of systems, methods, integrated circuits, computer programs, or recording media.

Now, an embodiment will be described with reference to the drawings.

The embodiment described below is a general or specific example of the present disclosure. The numerical values, shapes, materials, elements, the arrangement and connection of the elements, steps, step orders etc. shown in the following embodiments are thus mere examples, and are not intended to limit the scope of the present disclosure. Among the elements in the following embodiment, those not recited in the independent claims showing the broader concept will be described as optional.

### EMBODIMENT

### 1. Outline of Monitoring System

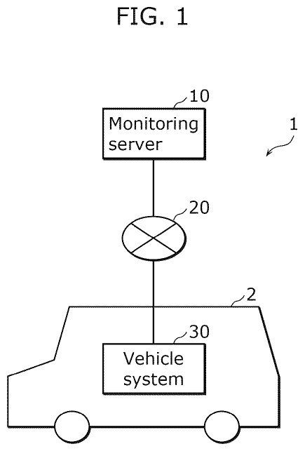

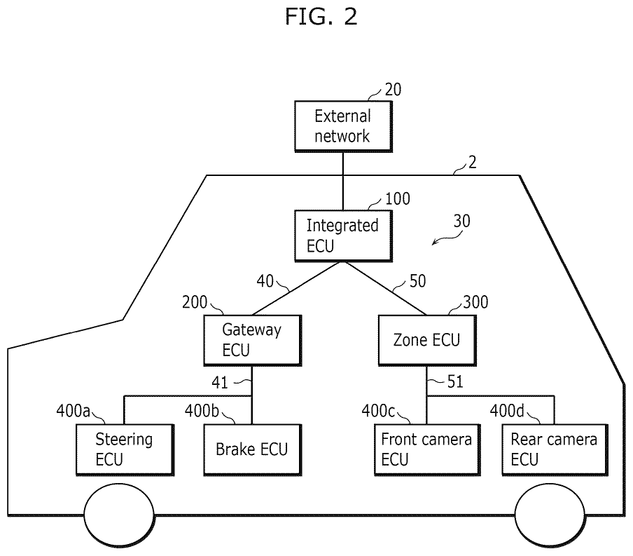

First, an outline of monitoring system 1 according to the embodiment will be described with reference to FIGS. 1 and 2. FIG. 1 shows the outline of monitoring system 1 according to the embodiment. FIG. 2 is a block diagram showing a configuration of vehicle system 30 according to the embodiment.

As shown in FIG. 1, monitoring system 1 includes monitoring server 10 and vehicle system 30. Monitoring server 10 and vehicle system 30 are communicably connected to each other via external network 20.

Monitoring server 10 is the following device. Upon detection of a security anomaly (hereinafter simply referred to as “anomaly”) in vehicle system 30, monitoring server 10 obtains information on the anomaly from vehicle system 30 and displays the details of the anomaly using a graphical user interface. The information on the anomaly obtained by monitoring server 10 is utilized to analyze the details of the anomaly at a security operation center, for example.

External network 20 is the Internet, for example. External network 20 may establish communications in a wired or wireless manner. Examples of the wireless communications include Wi-Fi (registered trademark), 3G/Long Term Evolution (LTE), Bluetooth (registered trademark), or V2X communications, which are known techniques.

Vehicle system 30 is an on-vehicle system mounted on vehicle 2 (an example of the mobility unit), such as an automobile. As shown in FIG. 2, vehicle system 30 includes integrated ECU 100 (an example of the monitoring device), gateway ECU 200, zone ECU 300, steering ECU 400a, brake ECU 400b, front camera ECU 400c, and rear camera ECU 400d.

Integrated ECU 100 and gateway ECU 200 are communicably connected to each other via a type of network protocol, control area network (CAN) 40. Here, the network protocol is not limited to the CAN but may be any protocol, such as CAN with flexible data rate (CAN-FD) or FlexRay (registered trademark), utilized in an existing on-vehicle system.

Integrated ECU 100 and zone ECU 300 are communicably connected to each other via a type of network protocol, Ethernet (registered trademark) 50. Ethernet 50 is the Scalable Service-Oriented MiddlewarE over IP (SOME/IP), for example. Here, the network protocol is not limited to the SOME/IP but may be any protocol, such as SOME/IP Service Discovery (SOME/IP-SD) or CAN with extended data length (CAN-XL), utilized in an existing on-vehicle system.

Integrated ECU 100 is for executing communication control, vehicle control, and display control. The communication control is for exchanging messages via external network 20, CAN 40 and Ethernet 50. The vehicle control is for instructing control of vehicle 2 via CAN 40 and Ethernet 50 to gateway ECU 200 and zone ECU 300. The display control is for outputting videos to an infotainment system and an instrument panel mounted on vehicle 2. Integrated ECU 100 is also for notifying monitoring server 10 of an anomaly detected by integrated ECU 100, via external network 20.

Gateway ECU 200 is for mediating the messages exchanged among integrated ECU 100, steering ECU 400a, and brake ECU 400b. Gateway ECU 200, steering ECU 400a, and brake ECU 400b are communicably connected to each other via CAN 41. Note that CAN 41 employs the same network protocol as CAN 40 described above.

Steering ECU 400a is for controlling the steering by a steering
mounted on vehicle 2.

Brake ECU 400b is for controlling a brake mounted on vehicle 2.

Zone ECU 300 is for mediating the messages exchanged among integrated ECU 100, front camera ECU 400c, and rear camera ECU 400d. Zone ECU 300, front camera ECU 400c, and rear camera ECU 400d are communicably connected to each other via Ethernet 51. Note that Ethernet 51 employs the same network protocol as Ethernet 50 described above.

Front camera ECU 400c is mounted at the front of vehicle 2 so as to obtain videos from a front camera that captures the front of vehicle 2.

Rear camera ECU 400d is mounted at the rear of vehicle 2 so as to obtain videos from a rear camera that captures the rear of vehicle 2.

Vehicle system 30 achieves control, such as travel, curve, or stop, of vehicle 2, using ECUs for controlling the engine and the body of vehicle 2 in addition to steering ECU 400a, brake ECU 400b, front camera ECU 400c, and rear camera ECU 400d. Vehicle system 30 may also achieve advanced driving support functions, such as autonomous driving, adaptive cruise control, or automatic parking, using an ECU for collecting various sensor information, such as the global positioning system (GPS).

### 2. Configuration of Integrated ECU

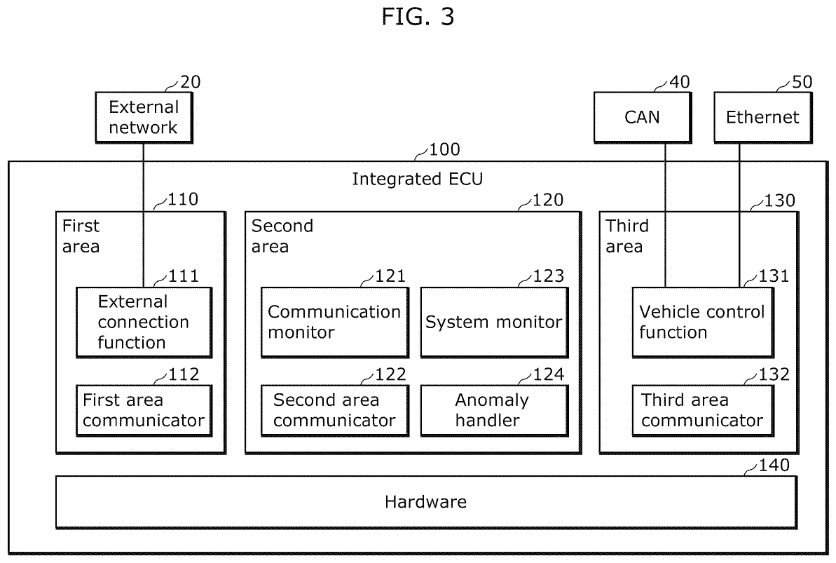

Next, a configuration of integrated ECU 100 according to the embodiment will be described with reference to FIG. 3. FIG. 3 is a block diagram showing an example configuration of integrated ECU 100 according to the embodiment.

As shown in FIG. 3, integrated ECU 100 includes external connection function 111, first area communicator 112, communication monitor 121, second area communicator 122, system monitor 123, anomaly handler 124, vehicle control function 131 (an example of the mobility unit control function), and third area communicator 132.

Integrated ECU 100 includes three software areas separated by one or more virtual machines, such as hypervisors, or one or more containers. The three software areas include first area 110, second area 120, and third area 130, and are executed on hardware 140. External connection function 111 and first area communicator 112 belong to first area 110. Communication monitor 121, second area communicator 122, system monitor 123, and anomaly handler 124 belong to second area 120. Vehicle control function 131 and third area communicator 132 belong to third area 130. Here, since the memories and namespaces are separate, the functions belonging to first area 110, the functions belonging to second area 120, and the functions belonging to third area 130 cannot interfere with each except a predetermined other communication means.

External connection function 111 is communicably connected to the outside of vehicle 2 via external network 20. Specifically, external connection function 111 transmits anomalies to monitoring server 10 via external network 20, for example. The anomalies include an anomaly in the communication detected by communication monitor 121, and an anomaly in the system detected by system monitor 123. External connection function 111 downloads software from an external server (not shown) via external network 20, based on the instruction on the update of the software from the external server, for example.

First area communicator 112 is a function that communicates between the functions belonging to first area 110, and the respective functions belonging to second area 120 and third area 130.

Communication monitor 121 is a function that monitors the communications between first area communicator 112 and third area communicator 132 by obtaining the communication contents between first area communicator 112 and third area communicator 132. Specifically, communication monitor 121 performs the following monitoring. (i) Communication monitor 121 does not monitor the communications within the same area of first area 110, second area 120, and third area 130. (ii) Communication monitor 121 monitors the communications from first area 110 to third area 130. (iii) Communication monitor 121 does not monitor the communications from third area 130 to first area 110. The details of communication monitor 121 will be described later.

Second area communicator 122 is a function that communicates between the functions belonging to second area 120 and the respective functions belonging to first area 110 and third area 130.

System monitor 123 is a function that monitors the separation function of the virtual machines, such as hypervisors, or the containers and the software of the areas. The details of system monitor 123 will be described later.

Once at least one of communication monitor 121 or system monitor 123 detects an anomaly, anomaly handler 124 has a function to cope with the detected anomaly. The details of the anomaly handler 124 will be described later.

Vehicle control function 131 is a function for instruction on control of vehicle 2 via CAN 40 and Ethernet 50. Example of vehicle control function 131 include function for instruction on steering by the steering of vehicle 2.

Third area communicator 132 is a function that communicates between the functions belonging to third area 130 and the respective functions belonging to first area 110 and second area 120.

At this time, assume that first area 110 is hacked by an attacker and compromised due to the vulnerability of external connection function 111. Even in this case, second area 120, to which communication monitor 121 belongs, and third area 130, to which vehicle control function 131 belongs, are separated from first area 110. It is thus not easy for the attacker to abuse communication monitor 121 and vehicle control function 131. If first area 110 and second area 120 are not separated and first area 110 is compromised, communication monitor 121 belonging to second area 120 may be bypassed. If first area 110 and third area 130 are not separated and first area 110 is compromised, vehicle control function 131, to which third area 130 belongs, may be abused by the attacker. In this manner, first area 110, to which external connection function 111 belongs, second area 120, to which communication monitor 121 belongs, and third area 130, to which vehicle control function 131 belongs, are separated, which can enhance the security.

While a case will be described in this embodiment where the software area is separated into the three software areas, the number is not limited thereto. The software area may be separated into four or more software areas. In this case, the four or more software areas include one first area 110, one second area 120, and one third area 130 described above. For example, if the software area is separated into four software areas, the four software areas include one first area 110, one second area 120, and two third areas 130. In this manner, fine separation of the software area enables efficient development and separation of a plurality of functions with different levels of risk into a plurality of areas, which can further enhance the security.

While system monitor 123 and anomaly handler 124 belong to second area 120 in this embodiment, the attribute is not limited thereto. System monitor 123 and anomaly handler 124 may belong to third area 130. If system monitor 123 and anomaly handler 124 belong to first area 110 and first area 110 is hacked by an attacker, system monitor 123 and anomaly handler 124 may be bypassed.

While third area 130 includes vehicle control function 131 in this embodiment, the function is not limited thereto. Third area 130 may include a safety function that is at least one of the following: (i) an internal connection function to be communicably connected to an internal network (e.g., an on-vehicle network, such as CAN 40, 41 or Ethernet 50, 51) constructed inside vehicle 2; (ii) vehicle control function 131; (iii) a vehicle information notification function (an example of the mobility unit information notification function) of notifying of vehicle information (an example of the mobility unit information) on vehicle 2; (iv) the software update function; or (v) the security function. In this case, second area 120 neither external connection function 111 nor the safety function.

### 3. Example Software Area

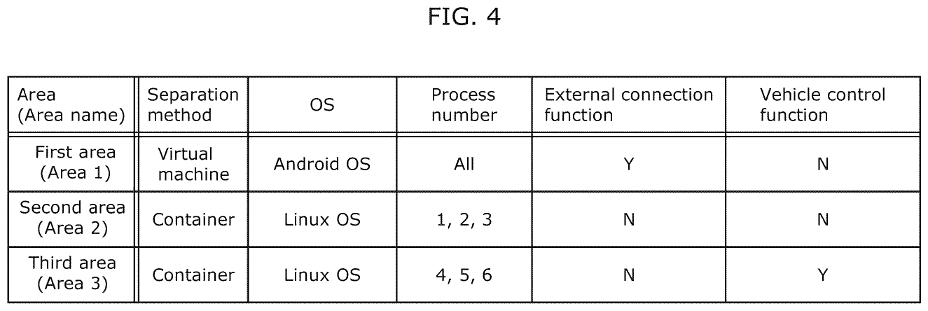

Next, an example software area according to the embodiment will be described with reference to FIG. 4. FIG. 4 shows an example software area according to the embodiment.

As described above, integrated ECU 100 includes first area 110, second area 120, and third area 130 that are the three software areas separated by one or more virtual machines, such as hypervisors, or one or more containers.

As shown in FIG. 4, first area 110 is represented as follows. (a) The area name is “area 1”. (b) The area is separated as a virtual machine. (c) The operating system (hereinafter referred to as “OS”) is the Android (registered trademark). (d) All the processes on the Android belong to first area 110. (e) The area has the external connection function. (f) The area has no vehicle control function.

Second area 120 is represented as follows. (a) The area name is “area 2”. (b) The area is separated as a container. (c) The OS is the Linux (registered trademark). (d) Processes 1, 2, and 3 on the Linux belong to second area 120. (e) The area has no external connection function. (f) The area has no vehicle control function.

Third area 130 is represented as follows. (a) The area name is “area 3”. (b) The area is separated as a container. (c) The OS is the Linux. (d) Processes 4, 5, and 6 on the Linux belong to third area 130. (e) The area has no external connection function. (f) The area has the vehicle control function.

While a case will be described in this embodiment where first area 110 is separated as a virtual machine and second area 120 and third area 130 are each separated as a container, the separation is not limited thereto. The areas may be separated by any separation technique of the virtual machines and the containers. This solves the problem of shortage of the resources for operating a plurality of virtual machines and enables more efficient development of the virtual machines on the same OS.

First area 110 has a lower reliability than the reliabilities of second area 120 and third area 130. Here, the reliabilities are each an index indicating the invulnerability to falsification by an attacker. With an increase in the vulnerability to falsification by an attacker, the reliability lowers. With a decrease in the vulnerability to falsification by an attacker, the reliability rises. In this case, an attacker has a higher possibility of attacking and falsifying first area 110 from external network 20. First area 110 thus has a lower reliability than the reliabilities of second area 120 and third area 130. On the other hand, second area 120 and third area 130 not connected to external network 20 include no interface to be directly attacked by an attacker and have lower possibilities of falsification. Second area 120 and third area 130 thus have lower reliabilities than the reliability of first area 110. If there is no second area 120 and first area 110 is falsified, a certain communication from first area 110 to third area 130 becomes possible and the safety function (e.g., vehicle control function 131) of third area 130 may be abused.

For example, the software area may be separated into three software areas by containers, not using any container technique, such as the Docker (registered trademark). One or more processes or a process group separated by at least one of namespace separation, system call limitation, limitation on calculation resource consumption, or forced access control may be treated as containers. This enables the separation of the software area with the least privilege per process unit, which can further enhance the security.

The namespace separation may be separation of at least one of the process identifier (PID) namespace, a network namespace, a mount namespace, the UNIX time-sharing system (UTS) namespace, the user identifier/group identifier (UID/GID) namespace, or the inter-process communication (IPC) namespace. If not separating any mount namespace, a container may limit file access under forced access control or certain access control. This enables the separation of proper namespaces and the separation of the software area with the least privilege per process unit, which can further enhance the security.

### 4. Example Communication of Integrated ECU

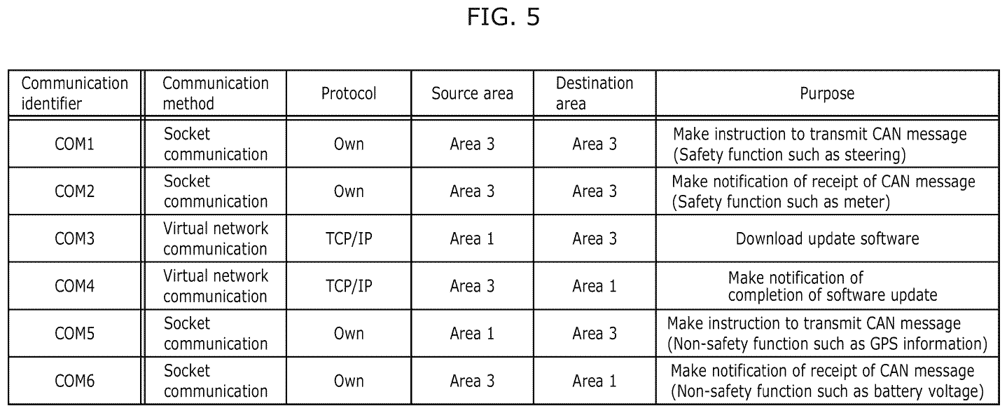

Next, an example communication of integrated ECU 100 according to the embodiment will be described with reference to FIG. 5. FIG. 5 shows the example communication of integrated ECU 100 according to the embodiment.

As shown in FIG. 5, integrated ECU 100 according to the embodiment establishes six types of communications each assigned with, for example, one of COM1 to COM6 as a communication identifier. Now, only representative communications will be described out of COM1 to COM6.

A communication with communication identifier COM1 is represented as follows. (a) The communication method is a socket communication. (b) The communication is established under its own protocol. (c) The source area is area 3. (d) The destination area is area 3. (e) The purpose of the communication is instruction on transmission of a CAN message related to the safety function, such as the steering. Even if communication COM1 is abused in an unauthorized manner from area 1, the abuse affects only the functions belonging to same area 1 and does not affect the safety function belonging to area 3. It is found that COM1 is a communication with a relatively low level of risk.

A communication with communication identifier COM3 is represented as follows. (a) The communication method is a virtual network communication. (b) The protocol is TCP/IP. (c) The source area is area 1. (d) The destination area is area 3. (e) The purpose of the communication is for downloading update software. If communication COM3 is abused in an unauthorized manner from area 1, there arises a higher risk that unauthorized software update becomes possible by an attacker. It is found that COM3 is a communication with a relatively high level of risk. To address the problem, communication monitor 121 checks that the vehicle status (an example of the mobility unit status) is software updating. If the vehicle status does not match, there is a need to deny communication COM3 transmitted from area 1.

Note that the virtual network may be a virtual network using VIRTIO-NET or may be a virtual network device or bridge on the Linux. Alternatively, the virtual network may be a virtual socket communication between virtual machines or may employ a virtual device communication, such as the VIRTIO-BLK. The socket communication may be the UNIX (registered trademark) domain socket or a communication using a message queue.

A communication with communication identifier COM6 is represented as follows. (a) The communication method is a socket communication. (b) The communication is established under its own protocol. (c) The source area is area 3. (d) The destination area is area 1. (e) The purpose of the communication is for notifying of receipt of a CAN message related to a non-safety function, such as the battery voltage. Even if communication COM6 is abused in an unauthorized manner from area 1, the abuse affects only the functions belonging to same area 1 and does not affect the safety function belonging to area 3. It is found that COM6 is a communication with a relatively low level of risk.

In this manner, integrated ECU 100 employs a plurality of types of communications in accordance with the purposes under different protocols. Unless communications are managed properly, damages by an attack may increase because of the abuse of inter-area communications, even if the software area is separated. Communication monitor 121 of integrated ECU 100 functions to reduce abuse of such inter-area communications by monitoring. Communication monitor 121 may perform serial monitoring by hooking or relaying inter-area communications, and may perform parallel monitoring by duplicating inter-area communications. On the communication-identifier-by-communication-identifier basis, the names of the source areas and the names of the destination areas can be defined in advance. As the communication identifiers, the identifiers included in the headers of the communication protocols may be utilized or the identifiers may be included in payloads.

### 5. Example Communication Monitoring Method

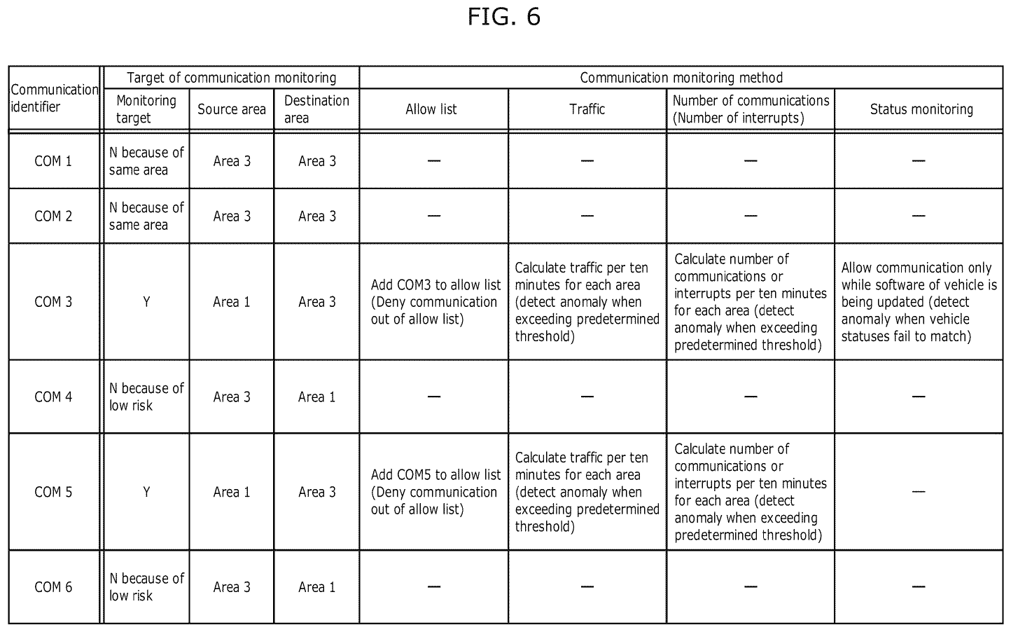

Next, an example communication monitoring method by communication monitor 121 according to the embodiment will be described with reference to FIG. 6. FIG. 6 shows the example communication monitoring method by communication monitor 121 according to the embodiment.

Now, only the communication monitoring method of monitoring the representative ones of communications COM1 to COM6 will be described.

It is shown in FIG. 6 that the communication with communication identifier COM1 is a communication within same area 3 and thus out of the communication monitoring target. This can reduce the load of the communication monitoring processing by communication monitor 121 as compared to the case of monitoring all the communications of COM1 to COM6.

It is shown that the communication with communication identifier COM3 has a relatively high risk of communication from area 1 to area 3 and is thus the target of communication monitoring. For the communication with communication identifier COM3, four types of the allow list, the traffic, the number of communications (or the number of interrupts), and the status monitoring are effective communication monitoring methods.
Here, the allow list is the list of communication identifiers indicating that whether to allow a communication for each source, each source area, or each destination area. If the communication identifier of a communication is out of the allow list, communication monitor 121 denies (i.e., shuts off) the communication with the communication identifier. On the other hand, if the communication identifier of the communication is on the allow list, communication monitor 121 allows the communication with the communication identifier. As shown in FIG. 5, the allow list for each source, each source area, or each destination area can be defined in advance.

The traffic is the following communication monitoring method. The traffic of virtual network communications is calculated in a predetermined time period (e.g., ten minutes) or in a predetermined vehicle status for each source or each source area. If the calculated traffic exceeds a predetermined threshold, the communication is determined to be anomalous. The traffic is also the following communication monitoring method. The traffic of socket communications is calculated in a predetermined time period for each source or each source area. If the calculated traffic exceeds the predetermined threshold, the communication is determined to be anomalous.

The number of communications (or the number of interrupts) is the following communication monitoring method. The number of communications or the number of interrupts of virtual network communication is calculated in a predetermined time period (e.g., ten minutes) for each source or each source area. If the calculated number of communications or interrupts exceeds a predetermined threshold, the communication is determined to be anomalous. In case of virtual network communication, the number of communications and the number of interrupts do not necessarily match. The monitoring may be performed using the number of interrupts instead of the number of communications. The number of communications is also the following communication monitoring method. The number of communications of socket communications may be calculated in a predetermined time period for each source or each source area. If the calculated number of communications exceeds a predetermined threshold, the communication is determined to be anomalous.

The status monitoring is the following communication monitoring method. The vehicle status is monitored. (i) If the vehicle status is within a specific range, the communications are allowed. (ii) If the vehicle status is out of the specific range, the communications are denied. For example, if a communication related to software update is to be transmitted while the vehicle is not updating software, communication monitor 121 denies the communication.

It is shown that the communication with communication identifier COM4 has a relatively low risk of communication from area 3 to area 1 and is thus out of the target of the communication monitoring. This can reduce the load of the communication monitoring processing by communication monitor 121 as compared to the case of monitoring all the communications of COM1 to COM6.

Note that a count value may be introduced that increments the number of communications (or the number of interrupts) at every transmission for each communication identifier or each area. Specifically, communication monitor 121 stores the count value of communications obtained by counting the number of communications for each source or the number of communications for each source area in a memory. Communication monitor 121 compares the count value of communications included in a communication between first area 110 and third area 130 to a value obtained by adding a predetermined value (e.g., “1”) to the count value of communications stored in the memory. If the values do not match, communication monitor 121 may detect an anomaly in the communication. This enables detection of unauthorized duplication of communications, spoofed communications, and other improper communications.

Assume that communication monitor 121 allows a communication between first area 110 and third area 130 as a result of conducting communication monitoring processing on the communication. In this case, communication monitor 121 may assign, to the communication, an identifier or a signature indicating that the communication monitoring processing has been executed. Accordingly, whether communication monitoring processing by communication monitor 121 has been bypassed can be easily checked based on the presence or absence of the identifier or the signature.

When denying a communication or detecting an anomaly, communication monitor 121 can determine that the source or the source area is anomalous.

While four types of communication monitoring methods (i.e., a allow list, traffic, the number of communications, and status monitoring) have been described in this embodiment, the number is not limited thereto. At least one type of a communication monitoring method may be conducted.

### 6. Example System Monitoring Method

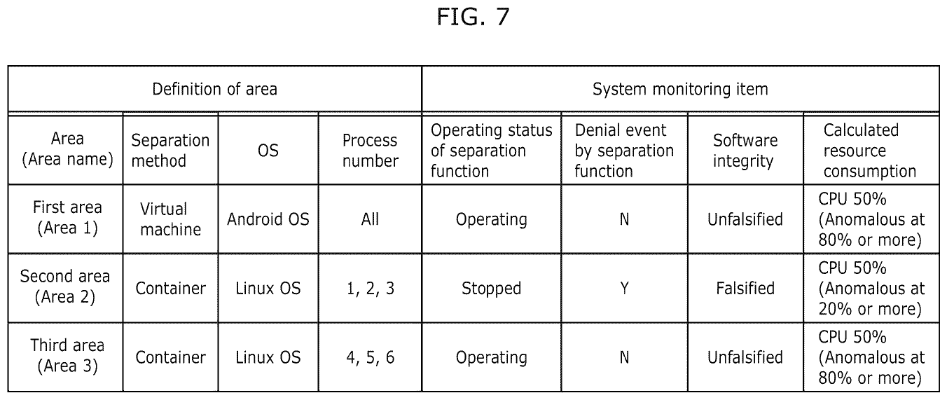

Next, an example system monitoring method by system monitor 123 according to the embodiment will be described with reference to FIG. 7. FIG. 7 shows the example system monitoring method by system monitor 123 according to the embodiment.

As shown in FIG. 7, system monitor 123 monitors, as the system monitoring items, (a) the operating status (or the settings) of the separation function, (b) the denial event by the separation function, (c) the integrity of the software, and (d) the calculation resource consumption.

Here, monitoring the operating status of the separation function is monitoring the operating status of the virtualization function that separates virtual machines at a runtime, when the software area is separated into virtual machines. On the other hand, monitoring the operating status of the separation function is monitoring the operating status of the function that separates the containers, such as namespace separation, system call limitation, limitation on calculation resource consumption, and forced access control at a runtime, when the software area is separated into containers. The operating status of the separation function is monitored, for example, every ten minutes. Accordingly, while the operating status of the separation function is “operating”, system monitor 123 determines that the software area is normally separated. While the operating status of the separation function is “stopped”, system monitor 123 detects an anomaly in the system, since the software area is not separated normally.

Monitoring a denial event by the separation function is monitoring a denial event of the virtualization function that separates virtual machines at a runtime, when the software area is separated into virtual machines. In this case, a denial event is, for example, a denial of hypercall or a denial of unallocated memory access. Monitoring the denial event by the separation function is also monitoring a denial event of the function that separates the containers, such as, namespace separation, system call limitation, limitation on calculation resource consumption, and forced access control at a runtime, when the software area is separated into containers. In this case, the denial event is, for example, a denial of an operation under forced access control, and a denial of a system call. Accordingly, if there is no denial event by the separation function, system monitor 123 determines that the software area is separated normally. If there is a denial event, system monitor 123 detects an anomaly in the system, since the software area is not separated normally.

Monitoring the integrity of the software is checking the integrity of part of all of the software included in each area at a runtime. The monitoring of the integrity of the software is achieved by obtaining a hash value of the monitoring target, for example, every ten minutes and comparing the obtained hash value to an expected value. If the values match, system monitor 123 determines that the area is unfalsified. If the values do not match, system monitor 123 detects an anomaly in the system, since the software area is falsified. The monitoring target software may be any of a user program, a separation function, or a setting value of the separation function.

Monitoring the calculation resource consumption is monitoring the resource consumption calculated by software included in each area. The calculation resource consumption may be monitored by obtaining the usage of the central processing unit (CPU) or the memory of the monitoring target software, for example, every ten minutes and comparing the usage to a reference value measured in advance. If the usage of the CPU or the memory is smaller than or equal to the reference value, system monitor 123 determines that the software is operating normally. If the usage of the CPU or the memory is larger than the reference value, system monitor 123 detects an anomaly in the system, since the software is operating anomalously.

The example shown in FIG. 7 shows the following as a result of conducting system monitoring in first area 110 (area 1) by system monitor 123. (a) The separation function is “operating”. (b) There is no denial event by the separation function. (c) The integrity of the software is “unfalsified”. (d) The calculation resource consumption is “CPU (usage) 50%”. In this case, since all the system monitoring items are normal, system monitor 123 determines that first area 110 is normal.

The following is shown as a result of conducting system monitoring in second area 120 (area 2) by system monitor 123. (a) The operating status of the separation function is “stopped”. (b) There is a denial event by the separation function. (c) The integrity of the software is “falsified”. (d) The calculation resource consumption is “CPU (usage) 50%”. In this case, since all the system monitoring items are anomalous, system monitor 123 determines that second area 120 is anomalous.

The following is shown as a result of conducting system monitoring in third area 130 (area 3) by system monitor 123. (a) The operating status of the separation function is “operating”. (b) There is no denial event by the separation function. (c) The integrity of the software is “unfalsified”. (d) The calculation resource consumption is “CPU (usage) 50%”. In this case, since all the system monitoring items are normal, system monitor 123 determines that third area 130 is normal.

As described above, system monitor 123 can determine that the area is anomalous when detecting at least one anomaly of the system monitoring items in a certain area.

The four types of system monitoring items (i.e., the operating status of the separation function, a denial event by the separation function, the integrity of the software, and calculation resource consumption) have been described in this embodiment. The number is not limited thereto. At least one of the four types of system monitoring items may be conducted.

System monitor 123 may monitor at least one of the following at a runtime: (i) the integrity, the settings, or the calculation resource consumption of the software of the separation function (i.e., the separation function itself) providing one or more virtual machines or one or more containers; or (ii) the integrity, the settings, or the calculation resource consumption of the software included in one or more virtual machines or one or more containers.

### 7. Example Anomaly Coping Method

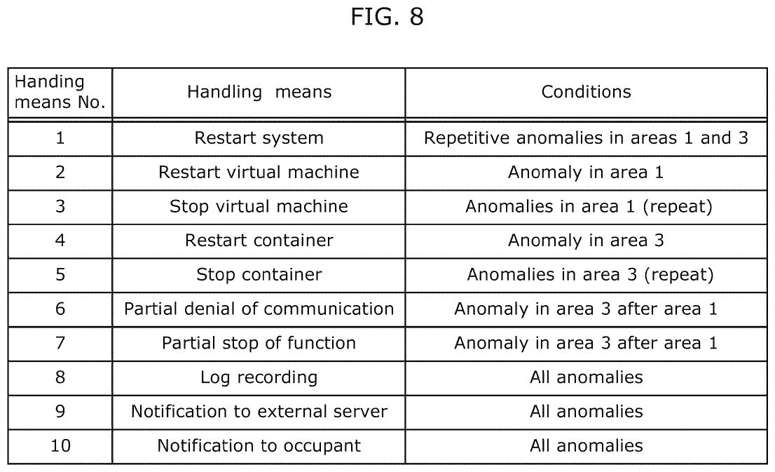

Next, an example anomaly coping method by anomaly handler 124 according to the embodiment will be described with reference to FIG. 8. FIG. 8 shows the example anomaly coping method by anomaly handler 124 according to the embodiment.

In the example shown in FIG. 8, anomaly handler 124 selects one of ten coping means in total based on at least one of the name of the area in which an anomaly has been detected (an example of the area number), the order of anomalies, or the number of anomalies. The coping means numbers “1”, “2”, . . . “10” are assigned to the ten coping means in total. Only the representatives of the ten coping means in total will be described.

It is shown that the coping means with coping means number “1” is system restart and selected when area 1 and area 3 are repeatedly anomalous. This means conducting the system restart as a coping means, when communication monitor 121 or system monitor 123 detects repetitive anomalies in area 1 and area 3. Anomaly handler 124 can grasp the repetitive anomalies by storing the number of anomalies occurring in each area. Accordingly, for example, even when each of area 1 and area 3 has a risk of being hacked by an attacker, the system can be restarted and back to safe conditions.

It is shown that the coping means with coping means number “6” is partial denial of communication and selected when area 3 is anomalous after area 1. This means denying the communication when communication monitor 121 or system monitor 123 detects an anomaly in each of area 1 and area 3, specifically, detects the anomaly in area 1 earlier than in area 3 in time order. Anomaly handler 124 can grasp the occurrence order of the anomalies by storing the times of detecting anomalies. Communication monitor 121 can specify the identifier, the source, or the source area of the anomalous communication. Accordingly, for example, when it is highly possible that area 1 is hacked and area 3 is attacked, only the communication assumed attacked (e.g., only communication COM3) can be denied.

It is shown that the coping means with coping means number “9” is notification to an external server (e.g., monitoring server 10) and selected when all types of anomalies occur. This means is notifying monitoring server 10, for example, of the details of the anomaly via external network 20, when communication monitor 121 or system monitor 123 detects an anomaly.

While the ten types of coping means (coping means number “1” to “10”) have been described in this embodiment, the number is not limited thereto. At least one of the ten types of coping means may be conducted.

### 8. Example Sequence of Communication Monitoring Processing

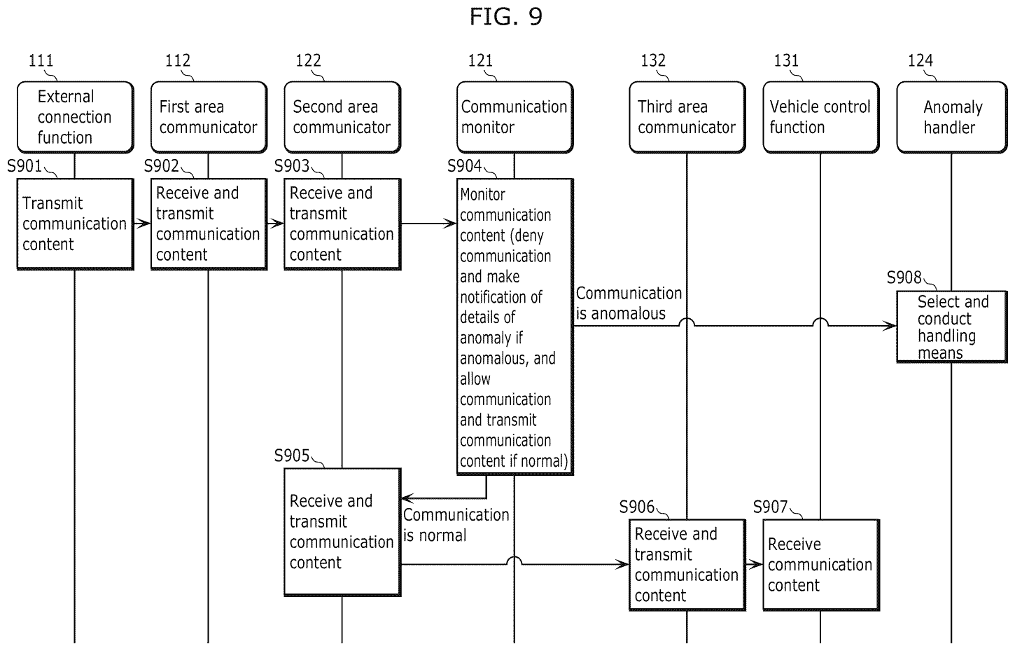

Next, an example sequence of communication monitoring processing by communication monitor 121 according to the embodiment will be described with reference to FIG. 9. FIG. 9 is a sequence diagram showing an example sequence of communication monitoring processing by communication monitor 121 according to the embodiment.

Now, a case where a communication content (data) is transmitted from external connection function 111 of first area 110 to vehicle control function 131 of third area 130 will be described.
(S901) External connection function 111 transmits, to first area communicator 112, the communication content to be transmitted to vehicle control function 131.
(S902) First area communicator 112 receives the communication content from external connection function 111 and transmits the received communication content to second area communicator 122.
(S903) Second area communicator 122 receives the communication content from first area communicator 112 and transmits the received communication content to communication monitor 121.
(S904) Communication monitor 121 monitors the communication content from second area communicator 122 and determines whether a communication related to the communication content is anomalous based on a result of monitoring the communication content. In case of normal communication, communication monitor 121 allows the communication and transmits the communication content to second area communicator 122. The process then proceeds to step S905. On the other hand, in case of anomalous communication, communication monitor 121 denies the communication and notifies anomaly handler 124 of the details of the anomaly. The process then proceeds to step S908. The details of the communication monitoring processing by communication monitor 121 will be described later.
(S905) Second area communicator 122 receives the communication content from communication monitor 121 and transmits the received communication content to third area communicator 132.
(S906) Third area communicator 132 receives the communication content from second area communicator 122 and transmits the received communication content to vehicle control function 131.
(S907) Vehicle control function 131 receives the communication content from third area communicator 132.
(S908) Anomaly handler 124 receives the details of the anomaly from communication monitor 121, selects a coping means in accordance with the received details of the anomaly, and conducts the selected means. The details of the anomaly coping processing by anomaly handler 124 will be described later.

### 9. Example Sequence of System Monitoring Processing

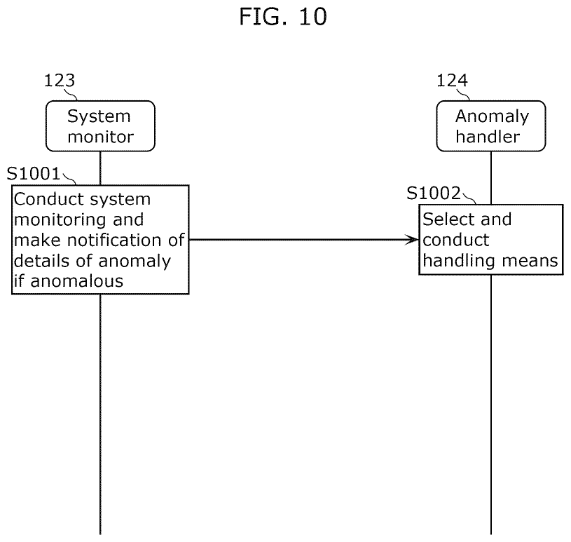

Next, an example sequence of system monitoring processing by system monitor 123 according to the embodiment will be described with reference to FIG. 10. FIG. 10 is a sequence diagram showing an example sequence of the system monitoring processing by system monitor 123 according to the embodiment.
(S1001) When detecting an anomaly as a result of conducting system monitoring, system monitor 123 of second area 120 notifies anomaly handler 124 of the details of the anomaly. The process then proceeds to step S1002. On the other hand, without detecting any anomaly, system monitor 123 ends the system monitoring processing. The details of the system monitoring processing by system monitor 123 will be described later.
(S1002) Anomaly handler 124 of second area 120 receives the details of the anomaly from system monitor 123, selects a coping means in accordance with the received details of the anomaly, and conduct the selected coping means. The details of the anomaly coping processing by anomaly handler 124 will be described later.

### 10. Example Communication Monitoring Processing

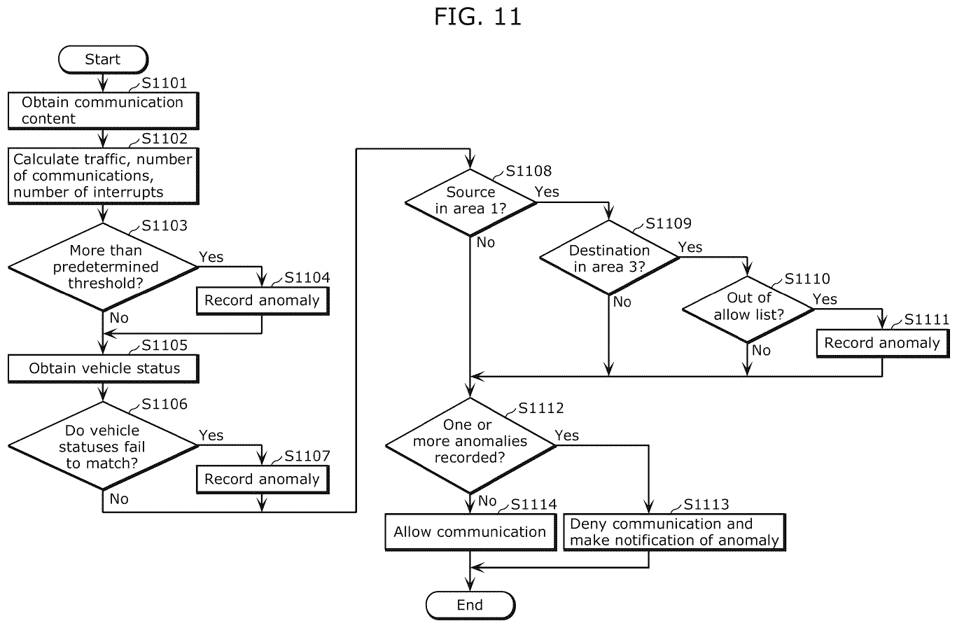

Next, an example flow of communication monitoring processing by communication monitor 121 according to the embodiment will be described with reference to FIG. 11. FIG. 11 is a flowchart showing the example flow of the communication monitoring processing by communication monitor 121 according to the embodiment.
(S1101) Communication monitor 121 obtains a communication content.
(S1102) Communication monitor 121 calculates the traffic, the number of communications, and the number of interrupts for each source or each source area based on the communication content obtained in step S1101, and stores the result of calculation.
(S1103) Communication monitor 121 determines whether any of the traffic, the number of communications, or the number of interrupts within a predetermined time period exceeds a predetermined threshold. If any of the traffic, the number of communications, or the number of interrupts within the predetermined time period exceeds the predetermined threshold (Yes in S1103), communication monitor 121 detects an anomaly in the communication. The process then proceeds to step S1104. On the other hand, if the traffic, each of the number of communications, and the number of interrupts within the predetermined time period is smaller than or equal to the predetermined threshold (No in S1103), communication monitor 121 determines that the communication is normal. The process then proceeds to step S1105. Note that the details of step S1103 are as described above with reference to FIG. 6.
(S1104) Communication monitor 121 stores the anomaly detected in step S1103. The process then proceeds to step S1105.
(S1105) Communication monitor 121 obtains the current vehicle status.
(S1106) Communication monitor 121 determines whether the vehicle status at the time of transmitting the communication content at step S1102 fail to match the current vehicle status obtained in step S1105. If the two vehicle statuses fail to match (Yes in S1106), communication monitor 121 detects an anomaly in the communication. The process then proceeds to step S1107. On the other hand, if the two vehicle statuses match (No in S1106), communication monitor 121 determines that the communication is normal. The process then proceeds to step S1108. Note that the details of step S1106 are as described above with reference to FIG. 6.
(S1107) Communication monitor 121 stores the anomaly detected in step S1106. The process then proceeds to step S1108.
(S1108) Communication monitor 121 determines whether the source are of the communication content in step S1102 is first area 110. If the source area is first area 110 (Yes in S1108), the process proceeds to step S1109. On the other hand, if the source area is not first area 110 (No in S1108), the process proceeds to step S1112.
(S1109) Communication monitor 121 determines whether the destination area of the communication content in step S1102 is third area 130. If the destination area is third area 130 (Yes in S1109), the process proceeds to step S1110. On the other hand, the destination area is not third area 130 (No in S1109), the process proceeds to step S1112.
(S1110) Communication monitor 121 refers to the source, the source area, and the communication identifier of the communication content in step S1102 and determines whether a communication related to the communication content is out of a allow list. If the communication fails is out of the allow list (Yes in S1110), communication monitor 121 detects an anomaly in the communication. The process then proceeds to step S1111. On the other hand, if the communication is on the allow list (No in S1110), the process proceeds to step S1112. Note that the details of step S1110 are as described above with reference to FIG. 6.
(S1111) Communication monitor 121 stores the anomaly detected in step S1110. The process then proceeds to step S1112.
(S1112) Communication monitor 121 determines whether one or more anomalies have been recorded. If one or more anomalies have been recorded (Yes in S1112), the process proceeds to step S1113. On the other hand, if no anomalies have been recorded (No in S1112), the process proceeds to step S1114.
(S1113) Communication monitor 121 denies the communication in step S1102, notifies anomaly handler 124 of the details of the anomaly, and ends the communication monitoring processing.
(S1114) Communication monitor 121 allows the communication in step S1102 and ends the communication monitoring processing.

Note that steps S1108, S1109, and S1110 are not necessarily executed in the order described above and may be executed in any order.

### 11. Example Flow of System Monitoring Processing

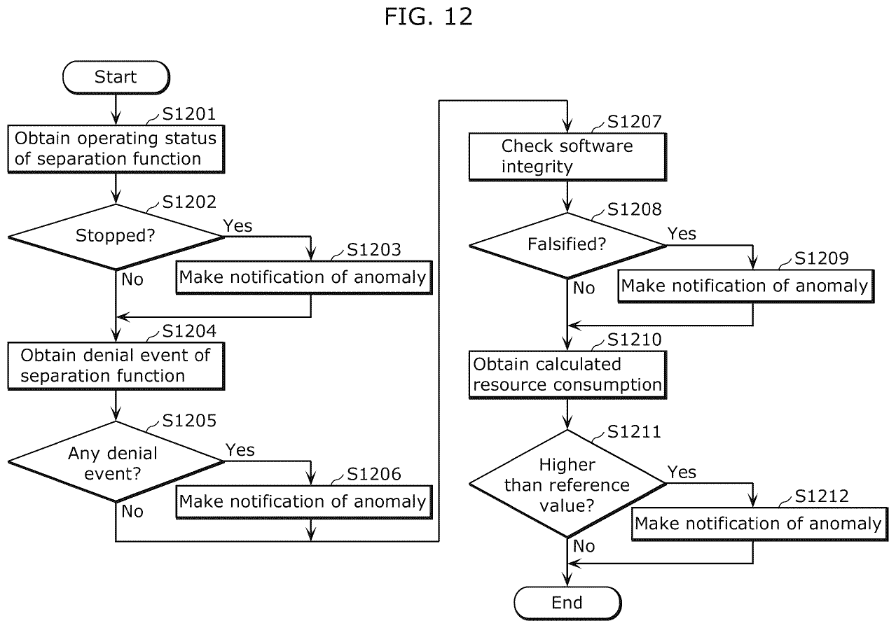

Next, an example flow of system monitoring processing by system monitor 123 according to the embodiment will be described with reference to FIG. 12. FIG. 12 is a flowchart showing the example flow of the system monitoring processing by system monitor 123 according to the embodiment.
(S1201) System monitor 123 obtains the operating status of a separation function.
(S1202) System monitor 123 determines whether the operating status of the separation function is “stopped”. While the operating status of the separation function is “stopped” (Yes in S1202), system monitor 123 detects an anomaly in the system. The process then proceeds to step S1203. On the other hand, while the operating status of the separation function is “operating” (No in S1202), the process proceeds to step S1204. Note that the details of step S1202 are as described above with reference to FIG. 7.
(S1203) System monitor 123 notifies anomaly handler 124 of the details of the anomaly detected in step S1202. The process then proceeds to step S1204.
(S1204) System monitor 123 obtains the denial event of the separation function.
(S1205) System monitor 123 determines whether there is a denial event by the separation function. If there is a denial event (Yes in S1205), system monitor 123 detects an anomaly in the system. The process then proceeds to step S1206. On the other hand, there is no denial event (No in S1205), the process proceeds to step S1207. Note that the details of step S1205 are as described above with reference to FIG. 7.
(S1206) System monitor 123 notifies anomaly handler 124 of the details of the anomaly detected in step S1205. The process then proceeds to step S1207.
(S1207) System monitor 123 conducts integrity check of software.
(S1208) System monitor 123 determines whether there is a falsification of the software. If there is a falsification of the software (Yes in S1208), system monitor 123 detects an anomaly in the system. The process then proceeds to step S1209. On the other hand, if there is no falsification of the software (No in S1208), the process proceeds to step S1210. Note that the details of step S1208 are as described above with reference to FIG. 7.
(S1209) System monitor 123 notifies anomaly handler 124 of the details of the anomaly detected in step S1208. The process then proceeds to step S1210.
(S1210) System monitor 123 obtains calculation resource consumption.
(S1211) System monitor 123 determines whether the calculation resource consumption is larger than a reference value. If the calculation resource consumption is higher than the reference value (Yes in S1211), system monitor 123 detects an anomaly in the system. The process then proceeds to step S1212. On the other hand, the calculation resource consumption is smaller than or equal to the reference value (No in S1211), system monitor 123 ends the system monitoring processing.
(S1212) System monitor 123 notifies anomaly handler 124 of the details of the anomaly detected in step S1211 and ends the system monitoring processing.

### 12. Example Flow of Anomaly Coping Processing

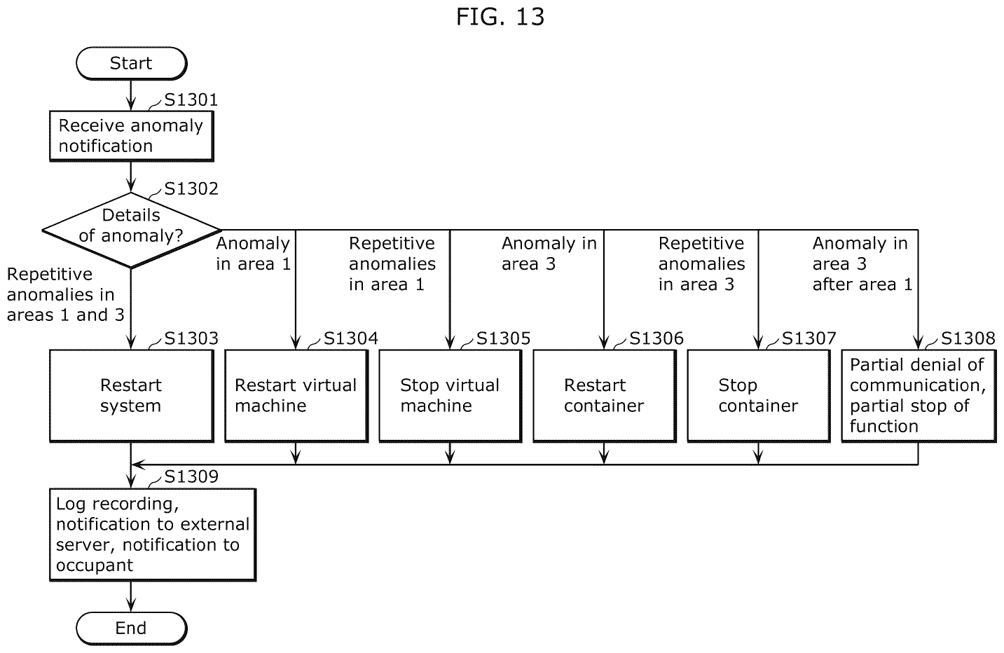

Next, an example flow of anomaly coping processing by anomaly handler 124 according to the embodiment will be described with reference to FIG. 13. FIG. 13 is a flowchart showing the example flow of the anomaly coping processing by anomaly handler 124 according to the embodiment.
(S1301) Anomaly handler 124 receives an anomaly notification from communication monitor 121 or system monitor 123.
(S1302) Anomaly handler 124 determines the details of the anomaly according to the anomaly notification received in step S1301. If areas 1 and 3 are repeatedly anomalous as the details of the anomaly (“Repetitive anomalies in areas 1 and 3” in S1302), the process proceeds to step S1303. If area 1 is anomalous as the details of the anomaly (“Anomaly in area 1” in S1302), the process proceeds to step S1304. If area 1 is repeatedly anomalous as the details of the anomaly (“Repetitive anomalies in area 1” in S1302), the process proceeds to step S1305. If area 3 is anomalous as the details of the anomaly (“Anomaly in area 3”) in S1302, the process proceeds to step S1306. If area 3 is repeatedly anomalous as the details of the anomaly (“Repetitive anomalies in area 3” in S1302, the process proceeds to step S1307. If area 3 is anomalous after area 1 has been anomalous as the details of the anomaly (“Anomaly in area 3 after area 1” in S1302), the process proceeds to step S1308.
(S1303) Anomaly handler 124 conducts restart of the system (coping means number “1” shown in FIG. 8) and then conducts step S1309.
(S1304) Anomaly handler 124 restarts the virtual machine (coping means number “2” shown in FIG. 8) and then conducts step S1309.
(S1305) Anomaly handler 124 stops the virtual machine (coping means number “3” shown in FIG. 8) and then conducts step S1309.
(S1306) Anomaly handler 124 restarts the container (coping means number “4” shown in FIG. 8) and then conducts step S1309.
(S1307) Anomaly handler 124 stops the container (coping means number “5” shown in FIG. 8) and then conducts step S1309.
(S1308) Anomaly handler 124 conducts partial denial of the communication or partial stop of the function (coping means number “6” or “7” shown in FIG. 8) and then conducts step S1309.
(S1309) Anomaly handler 124 records a log, notifies monitoring server 10 as an external server of the details of the anomaly, notifies the occupant of vehicle 2 of the details of the anomaly, and ends the anomaly coping processing.

### 13. Example Anomaly Display Function

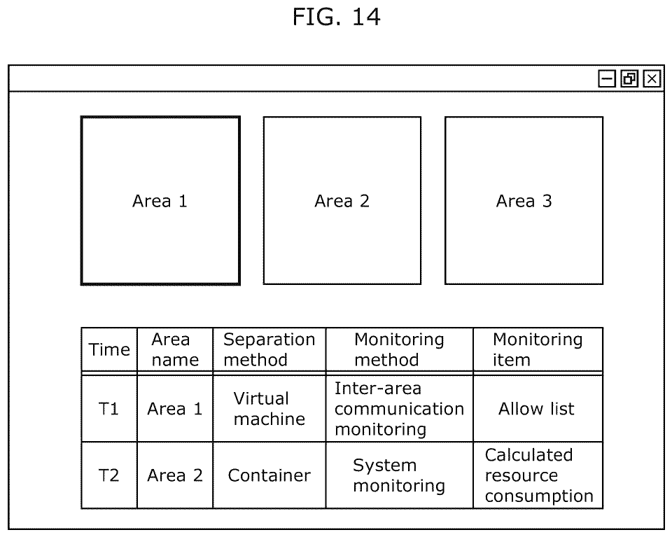

Next, an example anomaly display function to monitor server 10 will be described with reference to FIG. 14. FIG. 14 shows the example anomaly display function to monitor server 10 according to the embodiment.

Monitoring server 10 has an anomaly display function to display the details of the anomaly notified of by integrated ECU 100 of vehicle system 30 using a graphical user interface.

Specifically, as shown in FIG. 14, a monitor on a personal computer, for example, displays a screen for an anomaly display function. The upper stage of the screen displays three frames indicating “area 1”, “area 2”, and “area 3”. Out of the three frames, for example, the frame of “area 1” is in displayed bold, which indicates the occurrence of an anomaly in area 1.

The lower stage of the screen displays a table showing the detection time of the anomaly, the name of the area in which an anomaly has been detected, the separation method, the monitoring method, and the monitoring items (i.e., the details of the anomaly) in association with each other. The example shown in FIG. 14 shows that the anomaly is that the communication detected at time T1 in area 1 is out of the allow list.

This table shows the history of the anomalies detected before time T1. Specifically, the anomaly of the system detected at time T2, which is earlier than time T1, in area 2 is having larger calculation resource consumption than a reference value.

This enables intuitive understanding of the compromised area, which leads to more efficient analysis of the influences of an attack.

### (Other Embodiments)

The embodiment has been described above as an example technique according to the present disclosure. The technique according to the present disclosure is however not limited thereto and is applicable to embodiments obtained by appropriate changes, replacements, additions, omissions, etc. For example, the aspects of the present disclosure include the following variations.
(1) While a security measurement for a vehicle, such as an automobile, has been described above, the scope of application is not limited thereto. For example, the present disclosure is applicable not lonely to automobiles but to various mobility units, such as construction machinery, agricultural machinery, ships, trains, and airplanes.
(2) At least one of the devices described above is specifically, a computer system including a microprocessor, a ROM, a RAM, a hard disk unit, a display unit, a keyboard, a mouse, or other elements. The RAM or the hard disk unit stores computer programs. The microprocessor operates in accordance with the computer programs so that at least one of the device described above fulfill its function. Here, each computer program is obtained by combining a plurality of instruction codes indicating instructions to the computer so as to fulfill a predetermined function.
(3) Some or all of the elements of at least one of the devices described above may serve as a single system large-scale integrated (LSI) circuit. The system LSI circuit is a super multifunctional LSI circuit manufactured by integrating a plurality of components on one chip, and specifically is a computer system including a microprocessor, a ROM, and a RAM, for example. The RAM stores computer programs. The microprocessor operates in accordance with the computer programs so that the system LSI circuit fulfills its functions.
(4) Some or all of the elements at least one of the devices described above may serve as an IC card or a single module that is attachable to and detachable from the device. An IC card or a module is a computer system including a microprocessor, a ROM, a RAM, or other elements. The IC card or the module may include the multi-function LSI described above. The microprocessor operates in accordance with to the computer programs so that the IC card or the module fulfill its function. This IC card or this module may have a tamper resistance.
(5) The present disclosure may be directed to the method described above. The present disclosure may also be directed to a computer program implementing the method using a computer or digital signals indicating a computer program.

The present disclosure may be directed to computer programs or digital signals recorded in a recording medium, such as a flexible disc, a hard disk, a compact disc (CD)-ROM, a DVD, a DVD-ROM, a DVD-RAM, a Blu-ray (BD, registered trademark) Disc, or a semiconductor memory. The present disclosure may also be directed to digital signals recorded in such a recording medium.

The present disclosure is directed to computer programs or digital signals transmitted via a network represented by an communication line, a electrical wireless or wired communication line, and the Internet or data broadcasting, for example.

The programs or digital signals may be recorded in a recording medium and transferred, or transferred by a network, for example, and executed by another independent computer system.

### FURTHER INFORMATION ABOUT TECHNICAL BACKGROUND TO THIS APPLICATION

The disclosures of the following patent applications including specification, drawings, and claims are incorporated herein by reference in their entirety: Japanese Patent Application No. 2024-005691 filed on Jan. 17, 2024, and Japanese Patent Application No. 2024-071665 filed on Apr. 25, 2024.

### INDUSTRIAL APPLICABILITY

The monitoring device according to the present disclosure is applicable to an integrated ECU mounted on a vehicle system, for example.

1. A monitoring device mounted on a mobility unit, the monitoring device comprising:
three or more software areas separated by one or more virtual machines or one or more containers, wherein
the three or more software areas include a first area, a second area, and a third area,
the first area has a lower reliability than reliabilities of the second area and the third area, the reliability indicating invulnerability to falsification by an attacker, and
the monitoring device further includes a communication monitor that belongs to the second area and monitors a communication between the first area and the third area.

2. The monitoring device according to claim 1, wherein
the first area includes an external connection function to be communicably connected to an outside of the mobility unit via an external network,
the third area includes a safety function that is at least one of:
(i) an internal connection function to be communicably connected to an internal network constructed inside the mobility unit;
(ii) a mobility unit control function to control the mobility unit;
(iii) a mobility unit information notification function to notify of mobility unit information on the mobility unit;
(iv) a software update function; or
(v) a security function, and
the second area includes none of the external connection function and the safety function.

3. The monitoring device according to claim 1, wherein
the monitoring device includes four or more software areas separated by the one or more virtual machines or the one or more containers, and
the four or more software areas include one or more first areas, each being the first area, one or more second areas, each being the second area, and one or more third areas, each being the third area.

4. The monitoring device according to claim 1, wherein
each of the one or more containers is one or more processes or a process group separated by at least one of namespace separation, system call limitation, calculation resource consumption limitation, or forced access control.

5. The monitoring device according to claim 4, wherein
the namespace separation is a separation of at least one of a PID namespace, a network namespace, a mount namespace, an UTS namespace, an UID/GID namespace, or an IPC namespace, and
the one or more containers limit file access under forced access control or optional access control when not separating the mount namespace.

6. The monitoring device according to claim 1, wherein
the communication monitor
(i) does not monitor a communication within a same area of the first area, the second area, and the third area,
(ii) monitors a communication from the first area to the third area, and
(iii) does not monitor a communication from the third area to the first area.

7. The monitoring device according to claim 1, wherein
referring to a allow list indicating whether to allow a communication for each source area or each destination area, the communication monitor denies a virtual network communication or a socket communication not allowed on the allow list.

8. The monitoring device according to claim 1, wherein
the communication monitor monitors:
(i) traffic, a total number of communications, or a total number of interrupts of virtual network communications in a predetermined time period or in a predetermined mobility unit status, or
(ii) traffic or a total number of communications of socket communications in the predetermined time period for each source or each source area, and detects an anomaly in the communication between the first area and the third area when a value of a monitoring target exceeds a predetermined threshold.

9. The monitoring device according to claim 1, wherein
the communication monitor stores a count value of communications in a memory, the count value being obtained by counting a total number of communications for each source or a total number of communications for each source area, compares the count value of the total number of communications included in a communication between the first area and the third area and a value obtained by adding a predetermined value to the count value of communications stored in the memory, and detects an anomaly in the communication between the first area and the third area when the count value and the value do not match.

10. The monitoring device according to claim 1, wherein
when allowing a communication between the first area and the third area as a result of executing communication the communication, the monitoring processing on communication monitor assigns, to the communication, an identifier or a signature indicating that the communication monitoring processing has been executed.

11. The monitoring device according to claim 1, further comprising:
a system monitor that monitors an operating status or a setting of the separation function or a denial event by the separation function at a runtime, the separation function providing the one or more virtual machines or the one or more containers.

12. The monitoring device according to claim 1, further comprising:
a system monitor that monitors, at a runtime, at least one of:
(i) integrity, a setting, or a calculation resource consumption of a software of a separation function providing the one or more virtual machines or the one or more containers; or
(ii) integrity, a setting, or a calculation resource consumption of a software included in the one or more virtual machines or the one or more containers.

13. The monitoring device according to claim 1, further comprising:
an anomaly handler that copes with an anomaly detected by the communication monitor, wherein
the anomaly handler selects a coping means based on at least one of a number of the area in which an anomaly has been detected, an order of anomalies, or a total number of the anomalies, and
the coping means includes at least one of restart of a system, restart or stop of the one or more virtual machines, restart or stop of the one or more containers, partial denial of a communication, partial stop of a function, log recording, a notification to an external server, or a notification to an occupant of the mobility unit.

14. The monitoring device according to claim 11, further comprising:
an anomaly handler that copes with an anomaly detected by the communication monitor, wherein
the anomaly handler selects a coping means based on at least one of a number of the area in which an anomaly has been detected, an order of anomalies, or a total number of the anomalies, and
the coping means includes one of restart of a system, restart or stop of the one or more virtual machines, restart or stop of the one or more containers, partial denial of a communication, partial stop of a function, log recording, a notification to an external server, or a notification to an occupant of the mobility unit.

15. A monitoring system comprising:
a monitoring server; and
a monitoring device mounted on a mobility unit and communicably connected to the monitoring server via an external network, wherein
the monitoring device includes three or more software areas separated by one or more virtual machines or one or more containers,
the three or more software areas include a first area, a second area, and a third area,
the first area has a lower reliability than reliabilities of the second area and the third area, the reliability indicating invulnerability to falsification by an attacker, and
the monitoring device further includes:
a communication monitor that belongs to the second area and monitors a communication between the first area and the third area; and
an external connection function to notify the monitoring server of an anomaly in the communication, when the communication monitor detects the anomaly, and
the monitoring server has an anomaly display function to display details of the anomaly notified of by the monitoring device and an area in which the anomaly has occurred in association with each other.

16. A monitoring method using a monitoring device mounted on a mobility unit,
the monitoring device including three or more software areas separated by one or more virtual machines or one or more containers,
the three or more software areas including a first area, a second area, and a third area,
the first area having a lower reliability than reliabilities of the second area and the third area, the reliability indicating invulnerability to falsification by an attacker, and
the monitoring device further including a communication monitor that belongs to the second area,
the monitoring method comprising:
monitoring a communication between the first area and the third area, using the communication monitor.
